(19) United States
(12) Patent Application Publication
(10) Pub. No.: US 2016/0257056 A1
(43) Pub. Date: Sep. 8, 2016

(54) INNER COOLING BODY FOR A BLOWN FILM EXTRUSION LINE, BLOWN FILM EXTRUSION LINE COMPRISING SUCH AN INNER COOLING BODY AND METHOD FOR OPERATING SAID BLOWN FILM EXTRUSION LINE

(71) Applicant: REIFENHÄUSER GMBH & CO. KG MASCHINENFABRIK, Troisdorf (DE)

(72) Inventors: Holger SCHUMACHER, Sankt Augustin (DE); Christoph LETTOWSKY, Aachen (DE); Daniel BÜHL, Mannheim (DE)

(21) Appl. No.: 15/029,059

(22) PCT Filed: Sep. 22, 2014
(86) PCT No.: PCT/DE2014/000473

§ 371 Date: Apr. 13, 2016

(30) Foreign Application Priority Data
Oct. 13, 2013 (DE) 10 2013 016 898.8

(51) Int. Cl. B29C 49/64; B29C 49/42; B29C 49/28; B29C 49/04

(52) U.S. Cl. CPC B29C 49/64; B29C 49/04; B29C 49/4273; B29C 49/28; B29L 2023/001

(57) ABSTRACT

The formation of paraffin condensate on an inner cooling body of a blown film extruder can be either avoided or allowed in a controlled manner and then removed, thereby reducing damages to the film tube or even avoiding them. In an inner cooling body for a blown film extrusion line, the inner cooling body includes a shell around which a blown film tube, coming from the annular die, can ascend against gravity or can descend with gravity when the blown film extrusion line is running. The shell has a fraction condensate diverter for keeping paraffin condensate or any other condensate away from potential contact points of the blown film tube on the shell.

### CROSS-REFERENCE TO RELATED APPLICATIONS

This application is related to and claims the benefit of German Patent Application No. DE 10 2013 016 898.8, filed on Oct. 13, 2013, and PCT Application No. PCT/DE2014/000473, filed on Sep. 22, 2014, the contents of which are herein incorporated by reference in their entirety.

### TECHNICAL FIELD

The disclosure relates to an inner cooling body for a blown film extrusion line, a blown film extrusion line with such an inner cooling body and a method for operating such a blown film extrusion line. In particular, the disclosure relates to such an inner cooling body for a blown film extrusion line, said inner cooling body comprising a shell, around which a blown film tube, coming from the annular die, can ascend against gravity or can descend with gravity when the blown film extrusion line is running.

### BACKGROUND

Blown film extrusion lines have proven to be very useful in terms of reliable engineering for producing radially and axially stretched films from a melt. A polymer raw material, usually in the form of granules, is melted in an extruder. The melt is fed to a blow head with an annular die. From the annular die the polymer issues in the form of a polymer melt as a molding compound and, in particular, as a function of the orientation of the system, usually vertically downwards or vertically upwards, with the latter being generally regarded as the more modern approach. The air, which is blown into the interior of such a blown film tube, causes the blown film tube to expand. As a result, said blown film tube is stretched transversely to the direction of the machine. At the same time two take-off rolls at the upper end of the system pull the solidified and flattened blown film tube, which has arrived at said two take-off rolls, from the annular die at a higher speed than the delivery rate, so that the blown film tube is also stretched in the longitudinal direction.

The mechanical stretching takes place in the bottom area of the ascending blown film tube, when looking at a system that works from the bottom up, and it is such a system that for the sake of simplicity will be described hereinafter, it being understood that all of the following designs for a system that works the other way around are to be turned around in an analogous manner. Above the frost line the film tube can then undergo a calibration and a flattening; and, moreover, above the frost line the vulnerability of the film surface is significantly less than below the frost line.

In order to allow the film tube to solidify as fast as possible, i.e. in order to be able to set the frost line as low as possible, the film tube is generally supplied with cooling air not only from the outside, but it also has in its interior a so-called inner cooling body, through which, for example, a cooling liquid or cool air may pass, and/or a cool air flow may be generated inside the film tube.

However, now and then the film tube may make contact with or at least come very close to the surface of the inner cooling body.

Unfortunately, sometimes a condensation of paraffin (or other fractions condensation of low molecular weight) may occur on the inner cooling body. If a good unimodal polymer is processed on the blown film extrusion line, then this risk is quite small, because such a polymer is composed exclusively of constituents having a molecular weight that is close to a uniform value. However, already in the case of a worse unimodal polymer, i.e., in the case of a polymer, in which the constituents have a wider spread range of molecular weights, the proportion of constituents with a very low molecular weight, thus, for example, paraffin, increases significantly. The same problem is observed in the bimodal or multimodal polymers.

As soon as the paraffin condensate is on the surface of the inner cooling body, it is possible for the film to come into contact with the condensed paraffin if said film touches or comes close to the actual surface of the inner cooling body and, in so doing, can entrain the condensed paraffin. The result of such a phenomenon is an impairment of the visual quality of the film. Such a defect is often undesirable, especially if the film is intended for packaging consumer products.

The present disclosure improves the state of the art or provides an alternative device for conventional blown film extrusion lines.

### SUMMARY

According to a first aspect of the present disclosure, this is achieved by means of an inner cooling body for a blown film extrusion line, said inner cooling body comprising a shell, around which a blown film tube, which is generated by an annular die, may ascend against gravity or descend with gravity when the blown film extrusion line is running, wherein the shell has a paraffin condensate diverter for keeping the paraffin condensate away from any potential contact points of the blown film tube on the shell, i.e., for points on the shell that protrude radially outwards on the inner cooling body.

The terms that are used for this purpose are defined as follows.

The “inner cooling body” is defined as a body that is arranged between the annular die on the blow head and the take-off on the axis for the ascending or descending film and has an active cooling means, i.e., a means for flowing through the inner cooling body itself and/or the interior of the film.

The “shell” is roughly the surface of the inner cooling body, which is directed towards the ascending or descending film tube. The surface of the shell is not smooth, but rather has “radially outwards protruding points”. This means that when the smallest possible encircling line in the shape of a circular ring comes into contact with the shell on any level of the inner cooling body, based on the direction of the longitudinal extension of the inner cooling body, where in this case the smallest possible surround describes a plane perpendicular to the direction of the longitudinal extension of the inner cooling body, the smallest possible surround does not rest congruent to the shell, but rather has at least one contact point, preferably numerous contact points that are uniformly distributed around the circular surround, and also variations, which are also distributed, preferably uniformly, around the periphery in such a way that they are spaced apart. In simple words, the cross section of the inner cooling body does not have a circular shape, perpendicular to its direction of longitudinal extension at least over a defined longitudinal section along the direction of the longitudinal extension, but rather deviates from a circular shape. For example, the inner cooling body may have turbulence generating elevations on its shell, so that a turbulent air flow forms on the surface of the inner cooling body. This turbulent air flow produces a cushioning effect for the film and, in so doing, reduces the contact between the film and the inner cooling body.

The basic idea of the disclosure with respect to the paraffin condensate diverter is divided into two fundamental options. Condensation as such can be either reduced or even inhibited, or the condensing is intentionally allowed, but then controlled locally in such a way as to ensure that the condensate is removed systematically.

Therefore, according to the first approach, the paraffin condensate diverter comprises a paraffin condensation reducer or a paraffin condensation inhibitor.

It is to be explicitly noted that in accordance with the introduction of the specification the terms “paraffin” and, thus, “paraffin condensate” and “paraffin condensate diverter” are used passim throughout. However, these terms are used solely for the purpose of simplifying the language. What is claimed includes not only the concept of warding off the paraffin condensate, but also, in general, the concept of warding off any and all precipitation (not only in the form of condensate, but also in the form of sublimate), not only of paraffin, but also, in general, any and all precipitation of paraffin or other fractions that are released from the polymer molding compound. Whenever the term “paraffin condensate . . . ” is used within the scope of the present application, it is to be construed to mean that from a broader point of view it could also be replaced with the term “fraction condensate . . . ”.

According to one embodiment of the disclosure, such a paraffin condensation reducer or paraffin condensation inhibitor may comprise a continuous or discontinuous active heating means for the potential contact points on the shell. This idea is surprising because the inner cooling body is generally intended, after all, for cooling the surrounding air in the interior of the blown film tube. Naturally a heating means reduces the cooling effect. However, it is suggested that the heated surface area of the shell be distinctly smaller than the cooled surface area of the shell. It may be, for example, at most one-fifth, no more than one-tenth, at a maximum one-twentieth or even less than the proportion of the total surface area of the shell. In particular, the idea was to heat, very specifically, only the radially outwards protruding points of the shell, i.e., to provide, for example, with an electric heater or a heating fluid guide. The heating fluid guide does not even have to be implemented as a borehole in the inner cooling body, but rather may run, for example, along the outside as a pipe or tube.

An alternative or additional design of a paraffin condensation reducer or paraffin condensation inhibitor has a surface coating on the shell, especially sprayed and/or sintered, and/or has a surface finish. These methods are characterized by the fact that they modify the surface of the inner cooling body in relation to the actual material, from which the inner cooling body is made. The result is a modification, with the targeted effect that the paraffin condensate either no longer settles out or only settles out to a lesser extent.

Preferably, the paraffin condensate reducer or inhibitor is equipped with a holding means for non-destructive replacement, such as, for example, with a magnet connection, with a snap-in connection, with a clamp connection, with a bayonet connection or the like.

For example, a surface coating or the surface finish may comprise silicone or may be made of silicone; and/or the surface coating or the surface finish may comprise polytetrafluoroethylene (PTFE) or may be made thereof; and/or the surface coating or the surface finish may comprise rubber or may be made of rubber, in particular, natural rubber; and/or the surface coating or the surface finish may comprise chromium nitride or may be made thereof; and/or the surface coating or the surface finish may comprise an elastomer or may be made of an elastomer; and/or the surface coating or the surface finish may comprise a thermoelastic material or may be made of a thermoelastic material; and/or the surface coating or the surface finish may comprise a thermoplastic material or may be made of a thermoplastic material; and/or the surface coating or the surface finish may comprise ceramic or may be made of ceramic; and/or the surface coating may comprise graphite and/or diamond-like carbon [DLC]; and/or the surface finish may comprise ceramic or may be made of ceramic. It is to be explicitly noted that it is also possible to combine the aforementioned materials or material mixtures or, more specifically, natural products or mixtures of natural product materials. In addition, it is expressly pointed out that the term “coating” may be defined as a harder layer, in particular, with a higher indentation hardness of the surface than the indentation hardness of the base material, with the latter being, for example, steel.

Having conducted numerous experiments with various materials, the inventors selected the aforementioned materials as the most suitable. It is currently believed that the resulting advantageous effects on the surface tension or, more specifically, the surface energy are due to the materials. According to the basic principles of physics, substances of lower surface energy wet those substances of higher surface energy. The above materials, which have proven in tests to be highly advantageous, have, at least predominantly, a lower surface energy than paraffin or, generally speaking, than the low molecular weight fraction, the condensation of which is to be avoided. This is particularly true in the case of silicone. Based on concrete FIGURES, paraffin typically has, according to the measurements of the inventors, a surface energy ranging from 19 to 25.5 mN/m. However, PTFE generally has, for example, a surface energy between 15 mN/m and 21 mN/m. Nevertheless, it was also possible to obtain good results with PTFE.

Based on these ideas, it is proposed that the paraffin condensation reducer or paraffin condensation inhibitor have a region which has a surface energy of less than 19 mN/m, in particular, a surface energy of 15 mN/m to 19 mN/m, at the potential contact points on the shell, i.e., either at the points on the shell that protrude radially the furthest or at least at the points on the shell that do not protrude radially the least.

As an alternative, a coating may be provided that increases the surface energy.

Pursuing the second basic idea of the disclosure, the paraffin condensate diverter may have, as an alternative or in addition to a reducer or inhibitor, a paraffin condensate collecting duct, which is shielded from any potential contact points and is designed for the condensed paraffin, preferably with a local paraffin condensation enhancer on a supply line to the paraffin condensate collecting duct.

The terms that are used for this purpose herein are defined as follows.

The term “paraffin condensate collecting duct” should be construed as a duct, thus, not exactly wide open to the passing film, a feature that distinguishes it from conventional turbulence generating elevations on the inner cooling body, because in the case of the conventional design radially outwards open ducts form between the turbulence generating elevations. In contrast to the

conventional design, the present disclosure shields the paraffin condensate collecting duct as much as possible from the passing film tube, so that the movement in the film tube does not run the risk to moving into the region of the paraffin in the paraffin condensate collecting duct.

It is to be explicitly noted that within the entire scope of the present patent application the use of indefinite articles, such as “one”, “two” and so on, are usually understood to denote a minimum, thus, “at least one . . . ”, “at least two . . . ”, etc., unless it must be inferred otherwise from the context at each respective point or it is even expressly stated that what is meant at that point in the text is “exactly one . . . ”, “exactly two . . . ” and so on.

Although the concrete example refers to a paraffin condensate collecting duct, it is to be understood that one or more of such paraffin condensate collecting ducts should be present.

Despite its shielded design a supply line from the radially external points on the inner cooling body to the paraffin condensate collecting duct has to be present. In particular, said supply line can be designed in such a way that the condensed paraffin has slot-like possibilities for flowing on the surface of the shell from the radially external potential contact points of the film to the shielded paraffin condensate collecting duct.

Preferably a paraffin condensate collecting duct net extends over an entire longitudinal extension of the inner cooling body, but at least over a substantial part of the inner cooling body, in particular, at least over half of the longitudinal extension of the inner cooling body or over a one-third of the longitudinal extension of the inner cooling body. Otherwise, boreholes would be needed to guide the condensed paraffin from the ducts to the interior of the inner cooling body and from there conveyed further out of the system, a process that is generally deemed to be more complex and, thus, more cost intensive than to provide simply a continuous duct net externally on the inner cooling body, but under the shielding.

The local condensation enhancer is not just arranged preferably at the points on the inner cooling body that protrude radially the furthest on the outside or in any event do not protrude radially the least on the outside. For example, a cooling tube or a cooling pipe may be guided along the outside of the actual body of the inner cooling body, ideally below the same shielding, which also shields the paraffin condensate collecting duct. In particular, the paraffin condensate collecting duct may accommodate simultaneously the fluid guide for the cooling fluid, i.e., a cooling pipe or a cooling tube.

The inventors proceed on the assumption that when the radially external points are cooled locally, the paraffin has to be moved systematically to the condenser. Then it must be ensured that this paraffin is carried away as quickly as possible from any potential critical, radially external points of contact and that the paraffin flows to the paraffin condensate collecting duct or at least flows under the shielding.

Therefore, it is proposed to provide a heating system or a coating or a modification that lowers or raises the surface energy radially inside the points that are located radially the furthest on the outside.

As an alternative or in addition, it can be provided that the inner cooling body on the blown film extrusion line is designed to be alternately traversed by a cooling means and by a heating means or in any case to be cooled and heated alternately. During the cooling phases the paraffin condensate is deliberately produced; during the subsequent heating phases said paraffin condensate passes easily into the paraffin condensate collecting duct.

In a somewhat more complicated control system it is conceivable that regions on the inner cooling body can be heated or cooled simultaneously in opposite directions. In this way there are always cooled regions, in which the condensation of the paraffin can be selectively controlled.

In specific embodiments it is conceivable that the cooling means of the local condensation intensifier comprises a cooling coil, in particular, designed as a helical element and/or as an annular element. Special preference is given to the helical element, because it can extend ideally in one piece over the entire length or at least over a very long longitudinal distance of the inner cooling body along its direction of longitudinal extension, with, for example, the thought of allowing the helical element to run in a paraffin condensate collecting duct that also runs in the shape of a helix.

As an alternative or in addition, an embodiment of the disclosure can provide that the cooling means is part of a cooling device, which also comprises a second cooling means, where in this case the two cooling means can be subjected to different cooling capacities, so that different temperatures form on the inner cooling body.

A cooling means may be designed so as to be temperature controlled by thermoelectric means. This design makes it possible to selectively adjust locally a desired temperature or at least a temperature difference.

The supply line to the paraffin condensate collecting duct can run in the manner of a funnel from the potential contact points on the shell for collecting the paraffin condensate in the direction of the paraffin condensate collecting duct, with the paraffin condensate collecting duct being designed preferably as an annular gap on the inner cooling body.

The concept “an embodiment of a funnel-like inlet” is to be understood to mean that scales are attached to a central body of the inner cooling body with spacers towards the central body, where in this case the scales rest like a funnel on a radially external side of the paraffin condensate collecting duct. In simple words, such a design provides a surface that almost resembles a pine cone.

The scales are preferably configured as a plurality of individual elements. As an alternative, however, it can also be imagined that the scales are designed as an annular strip of sheet metal or a spiral strip of sheet metal, continuously or segmented, either over the entire circumference or even the spiral.

In order for the scales to have the effect of optimally facilitating the removal of the condensate and, at the same time, to be able to actually act like a funnel, it is suggested that the scales have an angle of less than 90 deg., preferably from 5 deg. to 30 deg., in the direction of the forces of gravity.

In order to support the removal effect of the condensate as an alternative or in addition to the angular position, it is proposed that the scales be attached to a heating device in such a way that said scales can be heated. In this case, the heating device is preferably fed from the interior of the inner cooling body and/or can be electrically supplied with power.

If the fish-scales can be heated differently, compared to the adjacent fish-scales, on the same inner cooling body, so that the temperature profile along the periphery and/or along the direction of the longitudinal extension of the inner cooling body can be selectively adjusted, then it is possible to have a greater effect on the accuracy of the film production.

It has already been stated that it may be advantageous if the scales can be heated thermoelectrically.

The currently preferred embodiment provides that a cooling means, in particular, in the form of a pipe or tube, for the scales also be arranged so as to be spaced apart radially outwards from the central body, serving as a spacer or an additional spacer preferably either radially outwards on the spacers and/or with the cooling means. In such a design pipe-shaped or tube-shaped conduits for a cooling means can be easily arranged externally on the surface of the central body of the inner cooling body, wherein the scales may be found radially outside of the tube or pipe, either mounted on the tube or the pipe, or with a spacer towards the inner heat sink.

It has already been explained that for the variant of the paraffin condensate collecting duct the basic idea that is to be achieved is a selective condensation of the paraffin, but then to remove the paraffin specifically from the region inside the film tube. For this purpose it is advantageous if the paraffin condensate collecting duct has a heating means for heating the paraffin condensate in a free flowing state and/or for evaporating the paraffin condensate.

In order to prevent the paraffin condensate collecting duct from running the entire condensate, it is possible to provide a reservoir for temporarily storing the paraffin condensate, either arranged, for example, in the run of the paraffin condensate collecting duct or at one of the ends of a paraffin condensate collecting duct.

It goes without saying that a blown film extrusion line, which is equipped with an inner cooling body, as described above, is also directly advantageous.

The same applies to a method for operating such a blown film extrusion line, wherein an inner cooling body is used and adjusted, as described above, in such a way that the paraffin condensate is kept as far away as possible from the potential contact points of the shell of the inner cooling body with the ascending or descending blown film tube, either by reducing or inhibiting the precipitation of the paraffin condensate at the potential contact points or by targeted generation and targeted removal of the paraffin condensate or both.

### BRIEF DESCRIPTION OF THE DRAWINGS

The disclosure is explained in more detail below by means of an exemplary embodiment with reference to the drawing. In the drawings:

FIG. 1 is a schematic form of one half of the inner cooling body in a longitudinal view along a short section along the direction of the longitudinal extension of the inner cooling body with a scale arrangement on spacers and a cooling tube.

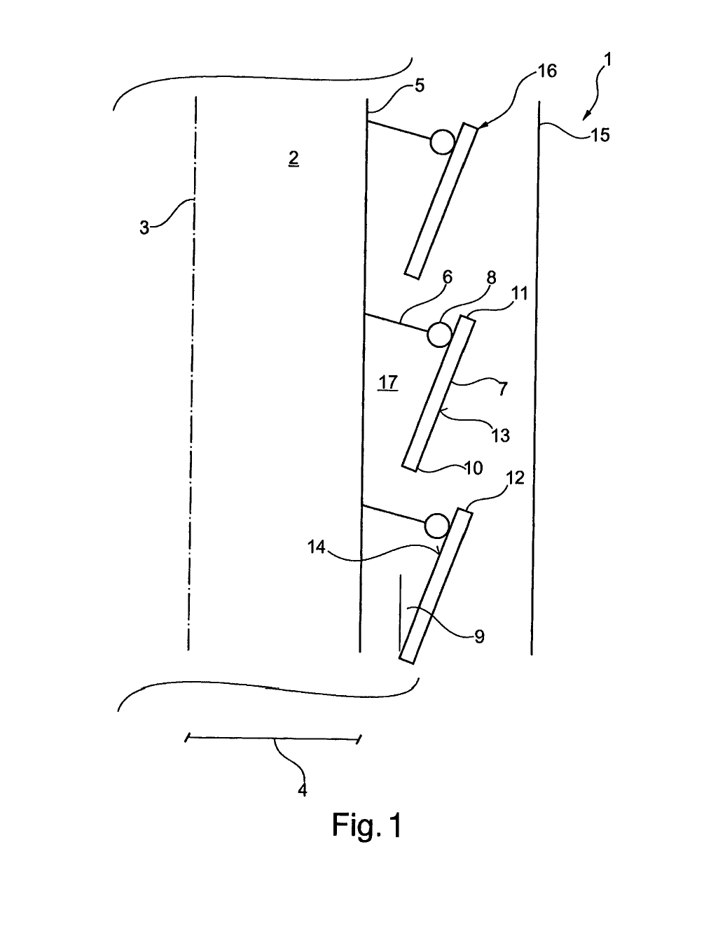

### DETAILED DESCRIPTION OF THE DRAWINGS

The inner cooling body 1 in the FIGURE (of which only a part is shown in the longitudinal view) includes a central body 2, which is usually made of metal and which has guides for air or a cooling liquid in its interior (not shown). The central body 2 and, thus, the entire inner cooling body 1 extend along a central axis 3, which, therefore, also defines the direction of the longitudinal extension of the inner cooling body 1.

A surface 5 of the central body 2 of the inner cooling body 1 is located at a distance 4 in relation to the central axis 3.

On the surface 5 there are fish-scales 7 (marked as an example) arranged with rod-shaped spacers 6 (marked as an example); and in particular, at each spacer 6 there is preferably precisely one scale 7.

However, the scales 7 are not arranged directly on the spacers 6. Instead, a cooling tube, which extends, for example, in a circular ring shape or spiral shape (the run of which is not shown), or a continuously running cooling tube 8 (shown as an example) is mounted on the spacers 6 first. Then the scales 7 are mounted externally on the cooling tube. For example, the scales 7 may be easily suspended from the cooling tube 8. Due to the mass distribution of the suspended scale (otherwise due to a specific attachment that defines the angle), said scale assumes an angle 9 in relation to the central axis 3, for example, about 20 deg.

A bottom end 10 (marked as an example) of a scale 7 is moved radially so much closer to the central body 2 than an associated upper end 11 of the same scale that the bottom end 10 of the scale is located radially further inwards than a subjacent upper end 12 of the underneath scale, and, in particular, preferably in such a way that the outer face 13 of a scale at the bottom end 10 of the scale 7 just does not end above the subjacent run of the cooling tube 8, but rather impinges, when viewed vertically, downwards on a scale inner face 14 of the subjacent scale.

In the normal operating mode of the blown film extrusion line (not shown) the inner cooling body 1 is used for cooling a film tube 15, which ascends preferably upwards.

Condensing paraffin will form predominantly on radially external condensation points 16 (labeled as an example), because the respective upper ends of the scales 7 at said condensation points are very cool. If drops of condensate were to develop at these points of condensation, they can easily run along the outer face 13 of the scales due to the force of gravity. As soon as the drops reach the bottom end 10 of the scales 7, the drop of paraffin condensate can simply drip downwards on the scale inner face 14 of the subjacent scale. This process continues from scale to scale, so that radially inside the scales a free duct 17 is used to remove the paraffin in the downward direction.

1. An inner cooling body for a blown film extrusion line, said inner cooling body comprising a shell, around which a blown film tube, coming from an annular die, ascends against gravity or descends with gravity when the blown film extrusion line is running, wherein the shell has a fraction condensate diverter configured to keep paraffin condensate or any other condensate away from a plurality of potential contact points of the blown film tube disposed on the shell that protrude radially outwards on the inner cooling body.

2. The inner cooling body, as claimed in claim 1, wherein the fraction condensate diverter comprises a fraction condensate reducer or a fraction condensation inhibitor.

3. The inner cooling body, as claimed in claim 2, wherein the fraction condensate reducer or the fraction condensate inhibitor comprises a continuous heat means or a discontinuous heat means for the potential contact points on the shell.

4. Inner cooling body, as claimed in claim 2, wherein the fraction condensate reducer or the fraction condensate inhibitor has a surface coating, the coating being sprayed, sintered, and/or a surface finish.

5. The inner cooling body, as claimed in claim 4, wherein the fraction condensate reducer or the fraction condensate inhibitor is configured to be exchanged without being destroyed, without any screws.

6. The inner cooling body, as claimed in claim 4, wherein the surface coating or the surface finish comprises silicone.

7. The inner cooling body, as claimed in claim 4, wherein the surface coating or the surface finish comprises polytetrafluoroethylene.

8. The inner cooling body, as claimed in claim 4, wherein the surface coating or the surface finish comprises rubber.

9. The inner cooling body, as claimed in claim 4, wherein the surface coating or the surface finish comprises chromium nitride.

10. The inner cooling body, as claimed in claim 4, wherein the surface coating or the surface finish comprises an elastomer.

11. The inner cooling body, as claimed in claim 4, wherein the surface coating or the surface finish comprises a thermosetting material.

12. The inner cooling body, as claimed in claim 4, wherein the surface coating or the surface finish comprises a thermoplastic material.

13. The inner cooling body, as claimed in claim 4, wherein the surface coating or the surface finish comprises ceramic.

14. The inner cooling body, as claimed in claim 4, wherein the surface comprises cork.

15. The inner cooling body, as claimed in claim 4, wherein the surface coating or the surface finish comprises diamond-like carbon and/or graphite.

16. The inner cooling body, as claimed in claim 4, wherein the surface coating has a higher indentation hardness than a base material of the inner cooling body.

17. The inner cooling body, as claimed in claim 2, wherein the fraction condensate reducer or the fraction condensate inhibitor at the potential contact points on the shell has a region with a surface energy of less than 19 mN/m.

18. The inner cooling body, as claimed in claim 2, wherein the fraction condensate reducer or the fraction condensate inhibitor at the potential contact points on the shell has a region with a surface energy of more than 19 mN/m.

19. The inner cooling body, as claimed in claim 1, wherein the fraction condensate diverter has a fraction condensate collector, which is shielded from the potential contact points, for condensed paraffin or other condensate in the form of condensate or sublimate, with a local condensation intensifier on a supply line to the fraction condensate collector, wherein the fraction condensate collector has a fraction condensate collecting duct and/or a fraction condensate remover.

20. The inner cooling body, as claimed in claim 19, wherein the condensation intensifier has a cooling means.

21. The inner cooling body, as claimed in claim 20, wherein the cooling means comprises a cooling coil designed as a helical element and/or as a ring element.

22. The inner cooling body, as claimed in claim 20, wherein the cooling means is part of a cooling device, which also comprises a second cooling means, wherein the two cooling means can be subjected to two different cooling capacities.

23. The inner cooling body, as claimed in claim 20, wherein the cooling means is designed to be temperature controlled thermoelectrically.

24. The inner cooling body, as claimed in claim 19, wherein the supply line to the fraction condensate collector runs like a funnel from the potential contact points on the shell for collecting the paraffin condensate or any other condensate to the fraction condensate collector, wherein the fraction condensate collector is designed as a fraction condensate collecting duct; and the fraction condensate collecting duct is designed as an annular gap on the inner cooling body.

25. The inner cooling body, as claimed in claim 19, wherein a plurality of scales are attached to a central body of the inner cooling body, with spacers towards the central body, wherein the scales lie like a funnel on a radially external side of the fraction condensate collector.

26. The inner cooling body, as claimed in claim 25, wherein the scales are designed as a plurality of individual elements.

27. The inner cooling body, as claimed in claim 25, wherein the scales are designed as an annular sheet metal strip or coiled sheet metal strip, either continuously or segmented.

28. The inner cooling body, as claimed in claim 25, wherein the scales comprise an angle of less than 90 deg. relative to the direction of the forces of gravity.

29. The inner cooling body, as claimed in claim 25, wherein the scales are attached to a heating device in such a way that it can be heated, wherein the heating device is fed from the interior of the inner cooling body.

30. The inner cooling body, as claimed in claim 29, wherein the scales are heated differently compared to the adjacent scales.

31. Inner cooling body, as claimed in claim 29, wherein the scales are heated thermoelectrically.

32. The inner cooling body, as claimed in claim 25, wherein a cooling means for the scales is also arranged so as to be radially outwards spaced apart from the central body, serving as a spacer or an additional spacer either radially outwards on the spacers and/or with the cooling means.

33. The inner cooling body, as claimed in claim 19, wherein the fraction condensate collecting duct has a heating means for holding the paraffin condensate or other condensate in a free flowing state and/or for evaporating the paraffin condensate or other condensate.

34. The inner cooling body, as claimed in claim 19, wherein the fraction condensate collecting duct has a reservoir for temporarily storing the paraffin condensate or other condensate.

35. A blown film extrusion line with an inner cooling body, as claimed in claim 1.

36. Method for operating a blown film extrusion line, as claimed in claim 35, wherein an inner cooling body, is used and optionally adjusted in such a way that the paraffin condensate or other condensate is kept as far away as possible from potential contact points of the shell of the inner cooling body with the ascending or descending blown film tube, and, either by reducing or inhibiting the condensation of the paraffin condensate or other condensate at the potential contact points or by targeted generation and targeted removal of the paraffin condensate or other condensate, or by both.
